(19) United States
(12) Patent Application Publication
(10) Pub. No.: US 2026/0217158 A1
(43) Pub. Date: Jul. 30, 2026

(54) SEAT RAIL TRACK COVER

(71) Applicant: YKK Corporation, Tokyo (JP)

(72) Inventors: Gerardo Diaz, Novi, MI (US); Mingming Zeng, Novi, MI (US); Mariano Cuerda, Novi, MI (US); Tsutomu Yamada, Novi, MI (US)

(21) Appl. No.: 19/395,628

(22) Filed: Nov. 20, 2025

Related U.S. Application Data
(60) Provisional application No. 63/751,408, filed on Jan. 30, 2025.

(51) Int. Cl. B60N 2/07

(52) U.S. Cl. CPC B60N 2/0725

(57) ABSTRACT

A rail track cover assembly for a seat rail for a vehicle seat includes a profile with opposing channels and a fastener between the opposing channels. The fastener includes a first elongated fastener segment and a second elongated fastener segment. The first elongated fastener segment includes a first set of fastener elements and a second set of fastener elements, and the second elongated fastener segment includes a third set of fastener elements and a fourth set of fastener elements. The second and third set of fastener elements are engaged in a releasable fashion, and at least one of the first or second set of fastener elements are retained in a channel of the profile.

### REFERENCE TO RELATED APPLICATION

This application claims the benefit of and priority to U.S. Provisional Patent Application No. 63/751,408, filed on Jan. 30, 2025, and entitled SLIDE RAIL TRACK COVER, the content of which is hereby incorporated by reference in its entirety.

### FIELD OF THE INVENTION

The invention relates to seat rails for vehicle seats, and more particularly, although not necessarily exclusively, to systems and methods for covering exposed portions of seat rails.

### BACKGROUND OF THE INVENTION

Seats in a vehicle, such as but not limited to an automobile, are often mounted in manner which may allow for limited movement of the seat relative to the vehicle. As an example, some vehicles include one or more elongated seat rails, and a seat includes a seat support structure which is movably supported on or in the one or more seat rails such that the seat may slide and/or is linearly moveable in a forward and back direction. The seat support structure occupies a portion of the seat rail while the remaining portions of the seat rail remain unoccupied. If those unoccupied portions are left exposed, dust, debris, and/or other materials may collect in the slide rail, potentially compromising operation of the seat support structure. Existing solutions for covering slide rails suffer from various disadvantages such as being complex and difficult to install, interfering with operation of the seat support structure, lacking sufficient coverage of the slide rail, and/or are not sufficiently durable.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a rail track cover assembly includes an elongated profile and a fastener. The elongated profile includes a first channel and a second channel opposite the first channel, and the first and second channels each extend along a length of the profile. The fastener extends along the length of the elongated profile and between the spaced apart channels of the elongated profile. In certain embodiments, the fastener includes a first elongated fastener segment with a first set of fastener elements and a second set of fastener elements and a second elongated fastener segment with a third set of fastener elements and a fourth set of fastener elements. In some embodiments, the second and third set fastener elements are engaged in a releasable fashion, and the first set of fastener elements are retained in the first channel.

According to various embodiments, a rail track cover assembly includes a fastener and a reel. The fastener includes a first elongated fastener segment with a first set of fastener elements extending along the first elongated fastener segment and a second elongated fastener segment with a second set of fastener elements extending along the second elongated fastener segment. The first set of fastener elements are configured to engage the second set of fastener elements in a releasable fashion. In some embodiments, the reel may wind up and/or store a disengaged portion of the first elongated fastener segment.

According to some embodiments, a rail track cover assembly includes a first profile, a second profile, and a fastener. The first profile component includes a first channel with a first opening along a first side of the first profile component, and the second profile component includes a second channel with a second opening along a second side of the first profile component and such that the second opening is spaced apart and facing the first opening. The fastener is between the first profile component and the second profile component. In certain embodiments, the fastener includes a first elongated fastener segment with a first set of fastener elements and a second set of fastener elements, a second elongated fastener segment with a third set of fastener elements and a fourth set of fastener elements, and a third elongated fastener segment with a fifth set of fastener elements and a sixth set of fastener elements. In various embodiments, the first set of fastener elements are retained in the first channel, the second and third set of fastener elements are engaged in a releasable fashion, the fourth and fifth set of fastener elements are engaged in a releasable fashion, and the sixth set of fastener elements are retained in the second channel.

According to certain embodiments, a rail track cover assembly includes an elongated profile with a first channel and a second channel, where the first and second channels are parallel to one another and extend along a length of the profile. The rail track cover assembly also includes a fastener extending along the length of the elongated profile between the spaced apart channels of the elongated profile. The fastener includes a first elongated fastener segment with a first set of fastener elements and a second set of fastener elements and a second elongated fastener segment with a third set of fastener elements and a fourth set of fastener elements. In certain embodiments, the first set of fastener elements are retained in the first channel of the elongated profile and the fourth set of fastener elements are retained in the second channel of the elongated profile.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a vehicle seat with a seat rail according to embodiments.

FIG. 2 illustrates a seat rail cover assembly for the seat rail of FIG. 1 according to embodiments.

FIG. 3 illustrates a fastener of the seat rail cover assembly of FIG. 2 according to embodiments.

FIG. 4 illustrates components of an elongated profile of the seat rail cover assembly of FIG. 2 according to embodiments.

FIG. 5 illustrates assembly of the fastener into one of the components of the elongated profile of the seat rail cover assembly of FIG. 2 according to embodiments.

FIG. 6 illustrates another fastener of the seat rail cover assembly of FIG. 2 according to embodiments.

FIG. 7 illustrates another seat rail cover assembly for the seat rail of FIG. 1 according to embodiments.

FIG. 8 illustrates a reel of the seat rail cover assembly of FIG. 7 according to embodiments.

FIG. 9 is another view of the seat rail cover assembly of FIG. 7 according to embodiments.

FIG. 10 is another view of the seat rail cover assembly of FIG. 7 according to embodiments.

FIG. 11 is another view of the seat rail cover assembly of FIG. 7 according to embodiments.

FIG. 12 illustrates inner features of the reel of the seat rail cover assembly of FIG. 7 according to embodiments.

FIG. 13 illustrates a fastener segment of the seat rail cover assembly of FIG. 7 according to embodiments.

FIG. 14 illustrates a vehicle seat structure with the seat rail cover assembly of FIG. 7 according to embodiments.

FIG. 15 illustrates a vehicle seat structure with another seat rail cover assembly according to embodiments.

FIG. 16 illustrates a vehicle seat structure with another seat rail cover assembly according to embodiments.

### DESCRIPTION OF THE INVENTION

Described herein are systems and methods for improved covering and/or protection of exposed portions of seat rails for a vehicle seat that are not occupied by a seat support structure. In certain embodiments, the systems and methods described herein utilize a profile supporting a fastener for selectively covering portions of a seat rail that is not occupied by the seat support structure.

The profile is an elongated profile and generally includes a first channel and a second channel that extend along a length of the profile. In some cases, a first profile component of the profile may include and/or define the first channel and a second profile component of the profile may include and/or define the second channel. The first and second profile components may be disconnected (e.g., separate components) or may be components of a monolithic or integrally formed profile. In certain embodiments, first and second profile components are vehicle seat rail trim pieces and/or may be connected to a vehicle seat rail. Optionally, the first and second profile components may at least partially cover the vehicle seat rail. The profile components and/or the channels may have various shapes or configurations as desired suitable for engaging a vehicle seat rail and a fastener, respectively.

The fasteners generally include at least a first fastener segment and a second fastener segment, although in other embodiments, fasteners described herein may include more than two fastener segments. As a non-limiting example, a fastener may include three fastener segments. In various embodiments, each fastener segment is generally elongated and includes sets of fastener elements along opposing sides of the fastener segment. The fastener elements may be various types of fastener elements suitable for engagement in a releasable fashion (e.g., the fastener elements may be selectively engaged or disconnected, such as by utilizing a slider or other suitable mechanism). As non-limiting examples, the fastener elements may be coils, teeth, combinations thereof, and/or other fastener elements as desired. In some embodiments, a fastener segment may include a fabric tape with fastener elements along opposing sides of the fabric tape. In other embodiments, a fastener segment may include a first tape secured to a second tape using various techniques as desired, such as but not limited to stitching, welding, sewing, combinations thereof, and/or as otherwise desired. In such embodiments, the first tape may form a first edge of the fastener tape segment and include a first set of fastener elements, and the second tape may form a second edge of the fastener tape segment and include a second set of fastener elements.

In various embodiments, the set of fastener elements along the edge of at least one fastener tape segment is retained in one of the channels of the profile. In such embodiments, the set of fastener elements long the opposing edge of the at least one fastener may be engaged with the set of fastener elements of another fastener tape segment in a releasable fashion.

Optionally, the systems and methods described herein include one or more storage devices for storing a disengaged portion of a fastener segment. In some embodiments, the storage device may include a reel which may be configured to wind up the disengaged portion of a fastener segment. Other storage devices may be utilized as desired. In other embodiments, the systems and methods described here need not include a storage device, and the systems and methods described herein may instead utilize a continuous fastener with a disengaged portion that goes through the seat support structure within the seat rail, under the seat support structure within the seat rail, or over the seat support structure within the seat rail.

Utilizing fasteners with fastener tape segments having fastener elements along opposing edges may provide improved modularity and an improved ability to cover seat rails, thereby reducing assembly time and manufacturing costs. As a non-limiting example, a fastener tape segment may be installed with either set of fastener elements within the channel. As another non-limiting example, a fastener tape segment may be selectively changed such that the set of fastener elements within the channel is changed as desired (e.g., if one set is damaged for releasable engagement purposes, it still may be utilized for engagement with the profile). The systems and methods described herein may effectively cover exposed portions of vehicle seat rails while maintaining ease of operation, durability, and aesthetic appeal. Various other benefits and advantages may be realized with the systems and methods provided herein, and the aforementioned advantages should not be considered limiting.

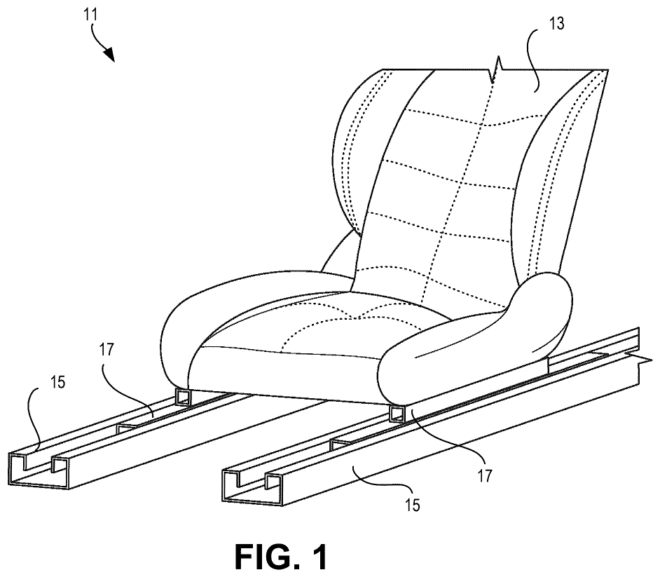

FIG. 1 illustrates an example of a seat assembly 11 with a seat 13 and seat rails 15. While two seat rails 15 are illustrated, a seat assembly 11 may include any number of seat rails as desired, such as one seat rail, two seat rails, three seat rails, etc. As illustrated in FIG. 1, a seat support structure 17 is positioned at least partially within a seat rail 15 and thus occupies a portion of the seat rail 15, while other portions of the seat rail 15 remain unoccupied. The seat support structure 17 is generally movable along the seat rail 15, and thus the portions of the seat rail 15 that are occupied or unoccupied may change based on the position of the seat support structure.

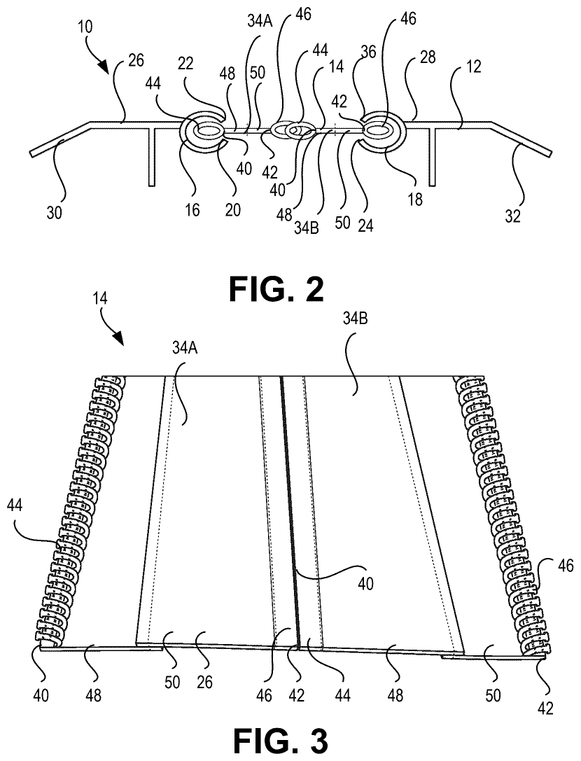

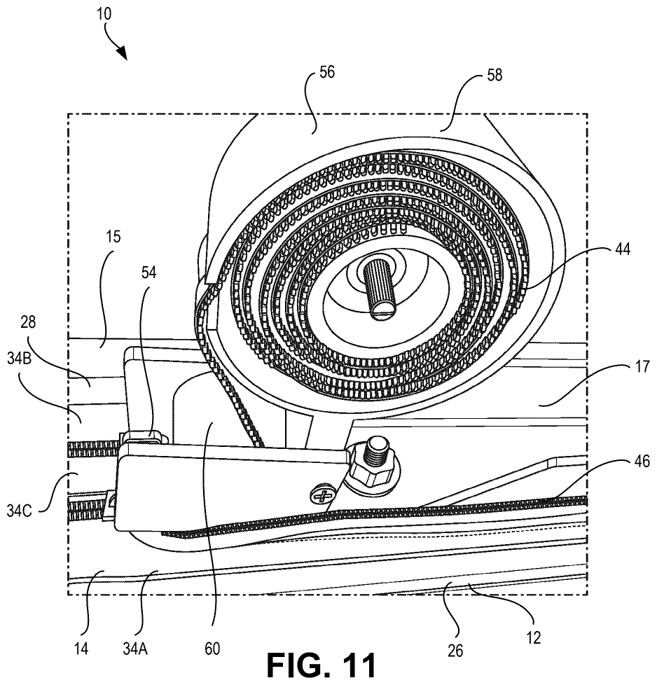

FIGS. 2-16 illustrate a seat rail cover assembly 10 for covering those portions of a seat rail 15 that are not occupied by the seat support structure 17. Without the seat rail cover assembly 10, those unoccupied portions of the seat rail 15 would remain exposed and open to receive dust, debris, and/or other items within the seat rail that may compromise the ability of the seat support structure 17 (and thus the seat 13) to move along the seat rail 15.

Referring to FIG. 2, the seat rail cover assembly 10 generally includes a profile 12 and a fastener 14. The profile 12 is elongated (in FIG. 2, the profile 12 is elongated in a direction into the page) and generally includes a first channel 16 and a second channel 18 which is spaced apart from the first channel 16. As illustrated in FIG. 2, the first channel 16 includes a first opening 20 along a first side 22 and the second channel 18 includes a second opening 24 along a second side 36. In some embodiments, and as illustrated in FIG. 2, the first and second channels 16, 18 are provided on the profile 12 such that the first opening 20 faces the second opening 24.

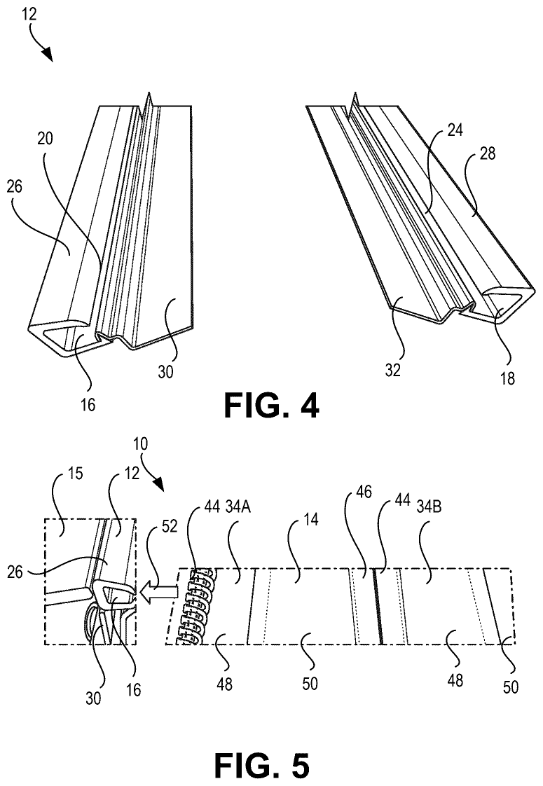

The first and second channels 16, 18 may have various shapes, profiles, and/or configurations as desired suitable for engaging fastener elements of the fastener 14 as described in detail below. As such, while the first and second channels 16, 18 are illustrated with “C” profiles in FIG. 2, in other embodiments they may have other profiles as desired. As a non-limiting examples, FIGS. 4 and 5 illustrate the first and second channels 16, 18 with a more squared profile compared to the C profile in FIG. 2. In various embodiments, a width or size of the openings 20, 24 may be less than a maximum width or size of the channels 16, 18. In certain cases, such relative dimensions may facilitate engagement and/or retention of fastener elements of the fastener 14 within the channels 16, 18 as described in detail below.

In some embodiments, the profile 12 includes a first profile component 26 with the first channel 16 and a second profile component 28 with the second channel 18. The first profile component 26 and the second profile component 28 may be separate and/or disconnected as illustrated in FIGS. 2 and 4, for example, although in other embodiments the profile 12 may be a one-piece construction and the profile components 26, 28 are monolithic or integrally formed.

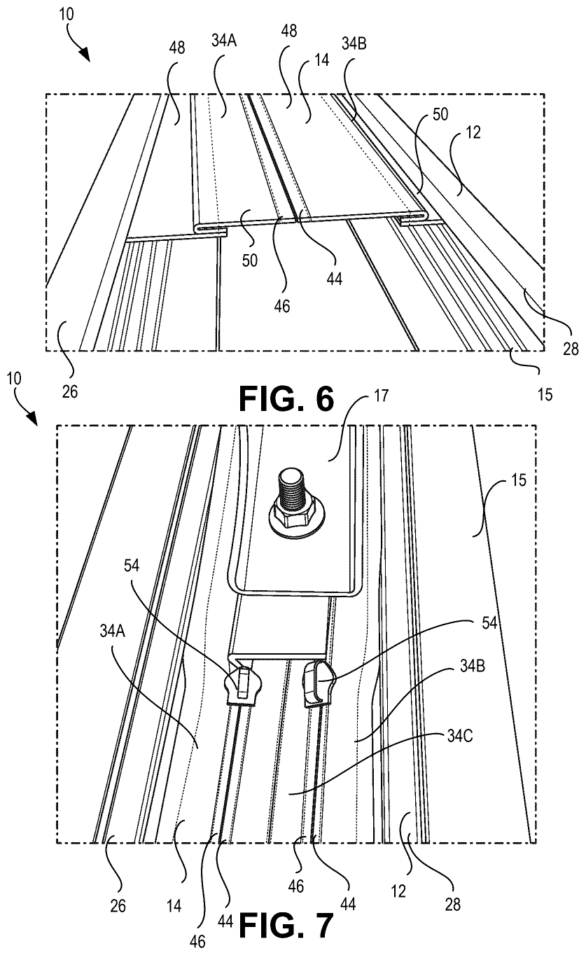

In certain embodiments, the first profile component 26 and the second profile component 28 are vehicle seat rail trim pieces, which may be connected to the vehicle seat rail 15. In some embodiments, and as illustrated in FIGS. 2 and 4, the profile components 26, 28 optionally include arms 30, 32 to facilitate engagement and/or connection with the vehicle seat rail 15. In some embodiments, and as illustrated in FIG. 2, the arms 30, 32 may extend downwardly relative to the channels 16, 18. However, in other embodiments, the arms 30, 32 may have other shapes or profiles as desired suitable for engaging the vehicle seat rail 15. In other embodiments, arms 30, 32 may be omitted, and the profile components 26, 28 may include other features suitable for engaging the vehicle seat rail 15. As illustrated in FIG. 6, when the profile components 26, 28 are connected to the vehicle seat rail 15, the profile components 26, 28 (as well as the fastener 14) at least partially cover the vehicle seat rail 15.

The profile 12 may be constructed from various materials or combinations of materials as desired. In a non-limiting example, the profile 12 may be constructed from a polymer material.

The fastener 14 of the seat rail cover assembly 10 is elongated like the profile 12. In certain embodiments, the fastener 14 extends along the length of the elongated profile 12 and between the channels 16, 18 (see, e.g., FIG. 2).

Referring to FIG. 2, for example, the fastener 14 generally includes at least two fastener segments 34, such as at least a first fastener segment 34A and a second fastener segment 34B. In some embodiments, the fastener 14 includes more than two fastener segments 34. As a non-limiting example, FIGS. 15 and 16 illustrate the fastener 14 with a third fastener segment 34C, and FIGS. 7-12 and 14 illustrate the fastener with the third fastener segment 34C and a fourth fastener segment 34D.

Each fastener segment 34 includes opposing edges 40, 42. A first edge 40 of each fastener segment includes a first set of fastener elements 44 and a second edge 42 of each fastener segment includes a second set of fastener elements 46. As described in detail below, the sets of fastener elements 44, 46 of one fastener segment may be retained in a channel 16, 18 and/or releasably engaged with fastener elements 44, 46. The fastener elements 44, 46 may be various types of fastener elements as desired suitable for engagement in a releasable fashion, including but not limited to coils, teeth (for example, plastic teeth and metal teeth), combinations thereof, and/or as otherwise desired. As non-limiting examples, the fastener elements 44, 46 in FIGS. 2-6 are coils, and the fastener elements 44, 46 in FIGS. 7-16 are teeth. In some embodiments, a fastener segment 34 may include a combination of types of fastener elements as desired. Other configurations of fastener elements 44, 46 may be utilized as desired.

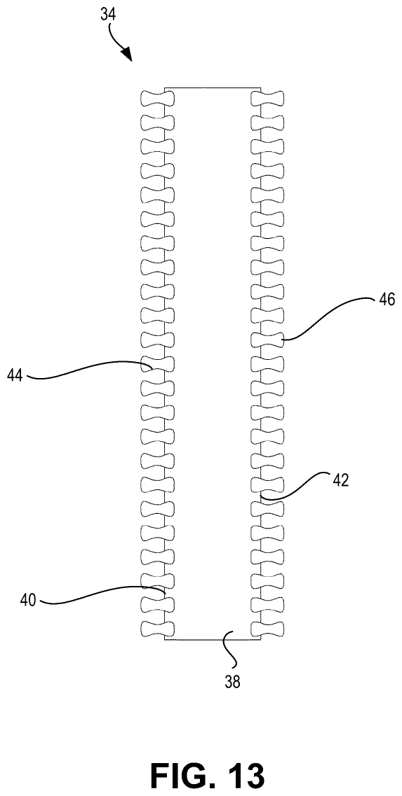

In some embodiments, a fastener segment 34 includes a body 38 having the opposing edges 40, 42 (see, e.g., FIG. 13). Additionally, or alternatively, a fastener segment 34 includes a first tape 48 secured to a second tape 50 (see, e.g., FIGS. 2-6, 9, and 10). In such embodiments, the first tape 48 may be secured to the second tape 50 using various mechanisms or techniques as desired, such as but not limited to stitching, sewing, welding, adhesive bonding, combinations thereof, and/or as otherwise desired. When the first tape 48 is secured to the second tape 50, the first tape 48 and the second tape 50 may be secured in various configurations as desired, such as but not limited to an edge-to-edge configuration (see, e.g., FIG. 2), an overlapping configuration (see, e.g., FIG. 3), a folded configuration (see, e.g., FIG. 6), combinations thereof, and/or as otherwise desired. In embodiments where a fastener segment 34 includes the first tape 48 and the second tape 50, the first tape 48 may define the first edge 40 and include the first set of fastener elements 44 along the first edge 40, and the second tape 50 may define the second edge 42 and include the second set of fastener elements 46 along the second edge 42.

As illustrated in FIG. 2, for example, and as represented by arrow 52 in FIG. 5, the fastener 14 is assembled with the profile by retaining opposing sets of fastener elements 44, 46 in the channels 16, 18.

As a non-limiting example, in the embodiment of FIG. 2 with the first and second fastener segments 34A-B, the first set of fastener elements 44 of the first fastener segment 34A is retained within the first channel 16 and the second set of fastener elements 46 of the second fastener segment 34B is retained within the second channel 18. In this example, the second set of fastener elements 46 of the first fastener segment 34A is engaged with the first set of fastener elements 44 of the second fastener segment 34B in a releasable fashion. One or more sliders 54 may be utilized to selectively engage or disengage portions of the first fastener segment 34A and the second fastener segment 34B. In this regard, in some embodiments, the fastener 14 optionally may be a slide fastener having two rows of teeth or rail that interlock when the slider 54 and/or other tool/function is pulled across them, and which is used to fasten or unfasten something. In other embodiments, the fastener 14 need not be a slide fastener.

In embodiment with more than two fastener segments 34 (e.g., the fastener 14 includes one or more intermediate fastener segment 34 between those fastener segments 34 engaged with the channels 16, 18), the intermediate fastener segments may be provided continuously or discontinuously along the length of the profile 12.

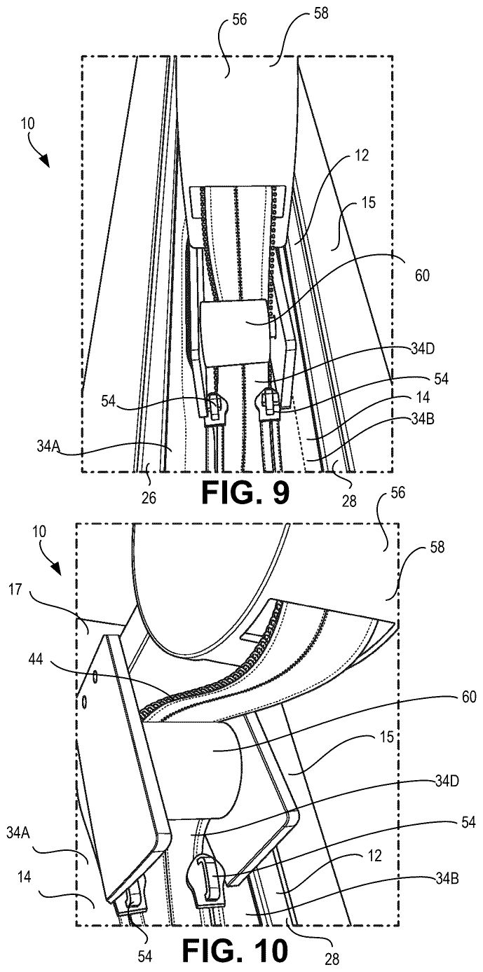

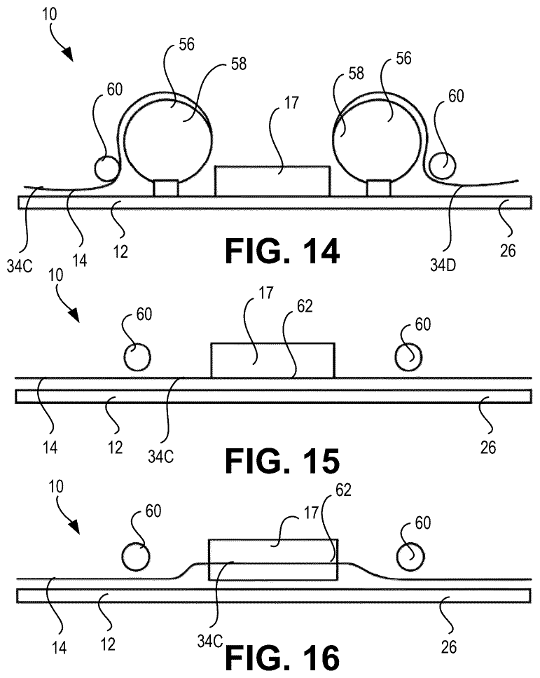

As a non-limiting example, the embodiment of FIGS. 7-12 and 14 illustrate the fastener 14 third and fourth fastener segments 34C-D which are both between the fastener segments 34A-B engaged with the channels 16, 18. In this embodiment, and as best illustrated in FIG. 14, the third and fourth fastener segments 34C-D are generally aligned with each other but discontinuous, and the seat rail cover assembly 10 includes storage devices 56 for storing disengaged portions of the third and fourth fastener segments 34C-D, respectively, and as described in detail below. Referring to FIGS. 9 and 10, in this example, the first set of fastener elements 44 of the first fastener segment 34A is retained within the first channel 16 and the second set of fastener elements 46 of the second fastener segment 34B are retained within the second channel 18. In this example, the second set of fastener elements 46 of the first fastener segment 34A is engaged with the first set of fastener elements 44 of the third fastener segment 34C as well as the first set of fastener elements 44 of the fourth fastener segment 34D, both in a releasable fashion. The first set of fastener elements 44 of the second fastener segment 34B is engaged with the second set of fastener elements 46 of the third fastener segment 34C as well as the second set of fastener elements 46 of the fourth fastener segment 34D, both in a releasable fashion. One or more sliders 54 may be utilized to selectively engage or disengage portions of the third and fourth fastener segments 34C-D from the first and second fastener segments 34A-B, respectively.

As another non-limiting example, FIGS. 15 and 16 illustrate the fastener 14 with a continuous third fastener segment 34C between the first and second fastener segments 34A-D and extending along the length of the profile 12. In these embodiments, a disengaged portion 62 of the third fastener segment 34C may pass or extend below the seat support structure 17 (see FIG. 15), through the seat support structure 17 (see FIG. 16), or above the seat support structure 17 as desired. In these examples, the first set of fastener elements 44 of the first fastener segment 34A is retained within the first channel 16 and the second set of fastener elements 46 of the second fastener segment 34B are retained within the second channel 18. In this example, the second set of fastener elements 46 of the first fastener segment 34A is engaged with the first set of fastener elements 44 of the third fastener segment 34C in a releasable fashion, and the second set of fastener elements 46 of the third fastener segment 34C is engaged with the first set of fastener elements 44 of the second fastener segment 34B in a releasable fashion.

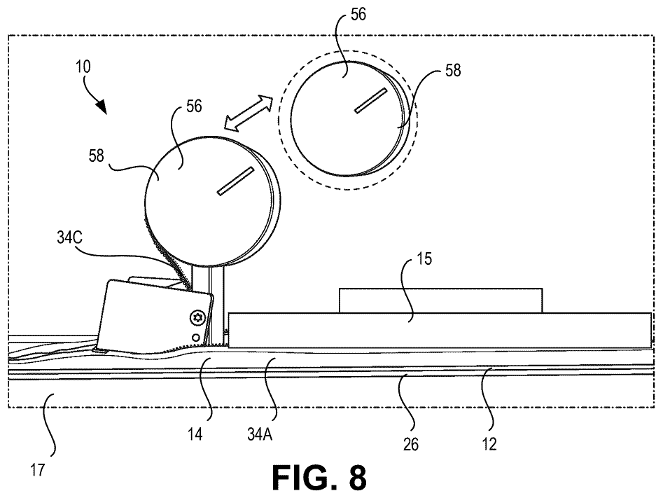

As mentioned, in some embodiments, the seat rail cover assembly 10 includes storage devices 56 for storing disengaged portions of the fastener segments. The storage devices 56 may be various devices or mechanisms as desired. In the embodiment illustrated in FIGS. 7-12, the storage devices 56 are reels 58 which are configured to wind up disengaged portions of the fastener segments 34C-D. Referring to FIG. 8, in some embodiments, the reels 58 may be provided with the seat support structure 17 and/or otherwise configured to move with the seat support structure 17, although in other embodiments they need not be and instead may be at another location as desired (represented by reel 58 in the broken circle).

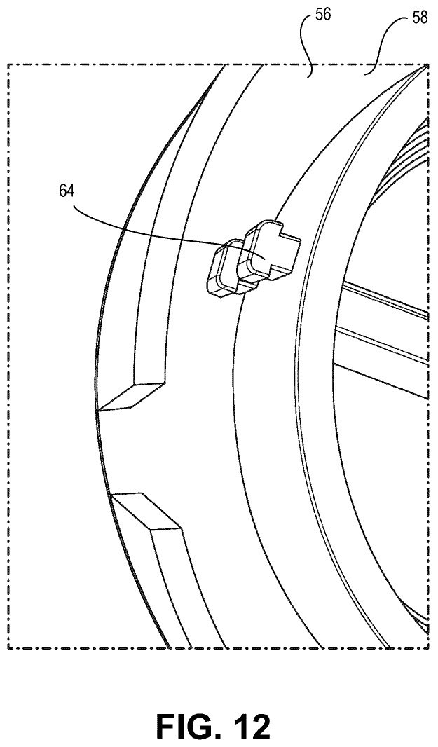

The reels 58 may include various features to facilitate winding and/or unwinding of the fastener segments. As a non-limiting example, the reels 58 may include a fastener segment guide 60 for guiding the fastener segment into or out of the reel 58. In other embodiments, and as illustrated in FIG. 1416, the seat rail cover assembly 10 optionally may include fastener segment guides 60 without the storage devices 56, such as but not limited to for guiding the fastener segment relative to the seat support structure 17. In other embodiments, the slide faster segment guides 60 may be omitted. Additionally, or alternatively, and as illustrated in FIG. 12, the reel 58 optionally may include a pillar or hook 64 within the reel 58 (e.g., within an area in which the wound fastener segment is stored) to selectively hold or fix the fastener segment within the reel 58. Other features or combinations of features may be utilized as desired. The particular reel 58 illustrated should not be considered limiting, and in other embodiments, the reel 58 may have various shapes and configurations, including but not limited to circular, oval, rectangular, or other geometric or non-geometric shapes. In embodiments with the reel 58, a specific shape of the reel 58 is less important than its function of storing the disengaged portion of the slide fastener segment. As a non-limiting example, in some embodiments, the reel 58 may be a non-circular shape to accommodate space constraints or other design considerations. Moreover, while the storage device 56 is illustrated as a reel 58, in other embodiments, other storage devices 56 may be utilized, and/or the storage devices 56 may be omitted (see, e.g., FIGS. 15 and 16).

As illustrated in FIGS. 6 and 7, for example, when the seat rail cover assembly 10 is assembled with the vehicle seat rail 15, at least the fastener 14 covers those portions of the vehicle seat rail 15 that are not occupied by the seat support structure 17, thereby limiting and/or preventing dust, debris, and/or other items from entering the vehicle seat rail 15 through those unoccupied portions. Various other benefits and advantages may be realized with the systems and methods provided herein, and the aforementioned advantages should not be considered limiting.

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.
Illustration 1. A rail track cover assembly comprising: an elongated profile comprising a first channel and a second channel opposite the first channel, wherein the first and second channels extend along a length of the profile; and a fastener extending along the length of the elongated profile between the spaced apart channels of the elongated profile, the fastener comprising: a first elongated fastener segment comprising a first set of fastener elements and a second set of fastener elements; and a second elongated fastener segment comprising a third set of fastener elements and a fourth set of fastener elements, wherein the second and third set fastener elements are engaged in a releasable fashion, and wherein the first set of fastener elements are retained in the first channel.
Illustration 2. The rail track cover assembly of any preceding or subsequent illustration or combination of illustrations, wherein the elongated profile comprises a first profile component comprising the first channel and a second spaced apart profile component comprising the second channel.
Illustration 3. The rail track cover assembly of any preceding or subsequent illustration or combination of illustrations, wherein the first and second channels are parallel to one another.
Illustration 4. The rail track cover assembly of any preceding or subsequent illustration or combination of illustrations, wherein the first and second profile components are vehicle seat rail trim pieces.
Illustration 5. The rail track cover assembly of any preceding or subsequent illustration or combination of illustrations, wherein the first and second profile components are connected to a vehicle seat rail.
Illustration 6. The rail track cover assembly of any preceding or subsequent illustration or combination of illustrations, wherein the first and second profile components and the fastener at least partially cover the vehicle seat rail.
Illustration 7. The rail track cover assembly of any preceding or subsequent illustration or combination of illustrations, wherein the first profile component comprises a first downwardly extending arm configured to engage the vehicle seat rail, and wherein the second profile component comprises a second downwardly extending arm configured to engage the vehicle seat rail.
Illustration 8. The rail track cover assembly of any preceding or subsequent illustration or combination of illustrations, wherein the first and second components are a polymer material and wherein the first and second fastener segments each comprise a fabric tape.
Illustration 9. The rail track cover assembly of any preceding or subsequent illustration or combination of illustrations, wherein the first set of fastener elements comprises a first coil, wherein the second set of fastener elements comprises a second coil, wherein the third set of fastener elements comprises a third coil, and wherein the fourth set of fastener elements comprises a fourth coil.
Illustration 10. The rail track cover assembly of any preceding or subsequent illustration or combination of illustrations, wherein: the first elongated fastener segment comprises a first tape secured to a second tape, wherein the first set of fastener elements is located along an edge of the first tape and the second set of fastener elements is located along an edge of the second tape; and the second elongated fastener segment comprises a third tape secured to a fourth tape, wherein the third set of fastener elements is located along an edge of the third tape and the fourth set of fastener elements is located along an edge of the fourth tape.
Illustration 11. The rail track cover assembly of any preceding or subsequent illustration or combination of illustrations, wherein the fourth set of fastener elements are retained in the second channel of the elongated profile.
Illustration 12. The rail track cover assembly of any preceding or subsequent illustration or combination of illustrations, wherein the fastener comprises at least one slider configured to cause portions of the second and third set of fastener elements to selectively engage or disengage, wherein the at least one slider is configured to move with a seat structure.
Illustration 13. A rail track cover assembly comprising: a fastener comprising: a first elongated fastener segment comprising a first set of fastener elements extending along the first elongated fastener segment; and a second elongated fastener segment comprising a second set of fastener elements extending along the second elongated fastener segment, the first set of fastener elements configured to engage the second set of fastener elements in a releasable fashion; and a reel configured to wind up a disengaged portion of the first elongated fastener segment.
Illustration 14. The rail track cover assembly of any preceding or subsequent illustration or combination of illustrations, wherein the fastener further comprises a third elongated fastener segment configured to engage the first elongated fastener segment in a releasable fashion, wherein the first elongated fastener segment is between the second and third elongated fastener segments.
Illustration 15. The rail track cover assembly of any preceding or subsequent illustration or combination of illustrations, further comprising: a fourth elongated fastener segment of the fastener between the second and third elongated fastener segments, the fourth elongated fastener segment configured to engage the second and third elongated fastener segments in a releasable fashion; and a second reel configured to wind up a disengaged portion of the fourth elongated fastener segment.
Illustration 16. The rail track cover assembly of any preceding or subsequent illustration or combination of illustrations, wherein the reel is configured to move with a seat structure.
Illustration 17. A rail track cover assembly comprising: a first profile component comprising a first channel, the first channel comprising a first opening along a first side of the first profile component; a second profile component comprising a second channel, the second channel comprising a second opening along a second side of the first profile component and such that the second opening is spaced apart and facing the first opening; and a fastener between the first profile component and the second profile component, the fastener comprising: a first elongated fastener segment comprising a first set of fastener elements and a second set of fastener elements; a second elongated fastener segment comprising a third set of fastener elements and a fourth set of fastener elements; and a third elongated fastener segment comprising a fifth set of fastener elements and a sixth set of fastener elements, wherein: the first set of fastener elements are retained in the first channel; the second and third set of fastener elements are engaged in a releasable fashion; the fourth and fifth set of fastener elements are engaged in a releasable fashion; and the sixth set of fastener elements are retained in the second channel.
Illustration 18. The rail track cover assembly of any preceding or subsequent illustration or combination of illustrations, wherein a portion of the third elongated fastener segment is configured to be disengaged from the first elongated fastener segment and the second elongated fastener segment based on movement of a seat structure.
Illustration 19. The rail track cover assembly of any preceding or subsequent illustration or combination of illustrations, wherein the disengaged portion of the third elongated fastener segment is configured to pass through the seat structure.
Illustration 20. The rail track cover assembly of any preceding or subsequent illustration or combination of illustrations, wherein the disengaged portion of the third elongated fastener segment is configured to pass above or below the seat structure.
Illustration 21. A rail track cover assembly comprising: an elongated profile comprising a first channel and a second channel, wherein the first and second channels are parallel to one another and extend along a length of the profile; and a fastener extending along the length of the elongated profile between the spaced apart channels of the elongated profile, the fastener comprising: a first elongated fastener segment comprising a first set of fastener elements and a second set of fastener elements; a second elongated fastener segment comprising a third set of fastener elements and a fourth set of fastener elements, wherein the first set of fastener elements are retained in the first channel of the elongated profile and wherein the fourth set of fastener elements are retained in the second channel of the elongated profile.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

Throughout this disclosure, a reference numeral with a letter refers to a specific instance of an element and the reference numeral without an accompanying letter refers to the element generically or collectively. Thus, as an example (not shown in the drawings), device “102A” refers to an instance of a device class, which may be referred to collectively as devices “102” and any one of which may be referred to generically as a device “102”. In the figures and the description, like numerals are intended to represent like elements.

As used herein, the meaning of “a,” “an,” and “the” includes singular and plural references unless the context clearly dictates otherwise.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A rail track cover assembly comprising:
an elongated profile comprising a first channel and a second channel opposite the first channel, wherein the first and second channels extend along a length of the profile; and
a fastener extending along the length of the elongated profile between the spaced apart channels of the elongated profile, the fastener comprising:
a first elongated fastener segment comprising a first set of fastener elements and a second set of fastener elements; and
a second elongated fastener segment comprising a third set of fastener elements and a fourth set of fastener elements,
wherein the second and third set fastener elements are engaged in a releasable fashion, and
wherein the first set of fastener elements are retained in the first channel.

2. The rail track cover assembly of claim 1, wherein the elongated profile comprises a first profile component comprising the first channel and a second spaced apart profile component comprising the second channel.

3. The rail track cover assembly of claim 2, wherein the first and second channels are parallel to one another.

4. The rail track cover assembly of claim 2, wherein the first and second profile components are vehicle seat rail trim pieces.

5. The rail track cover assembly of claim 4, wherein the first and second profile components are connected to a vehicle seat rail.

6. The rail track cover assembly of claim 5, wherein the first and second profile components and the fastener at least partially cover the vehicle seat rail.

7. The rail track cover assembly of claim 5, wherein the first profile component comprises a first downwardly extending arm configured to engage the vehicle seat rail, and wherein the second profile component comprises a second downwardly extending arm configured to engage the vehicle seat rail.

8. The rail track cover assembly of claim 2, wherein the first and second components are a polymer material and wherein the first and second fastener segments each comprise a fabric tape.

9. The rail track cover assembly of claim 1, wherein the first set of fastener elements comprises a first coil, wherein the second set of fastener elements comprises a second coil, wherein the third set of fastener elements comprises a third coil, and wherein the fourth set of fastener elements comprises a fourth coil.

10. The rail track cover assembly of claim 1, wherein:
the first elongated fastener segment comprises a first tape secured to a second tape, wherein the first set of fastener elements is located along an edge of the first tape and the second set of fastener elements is located along an edge of the second tape; and
the second elongated fastener segment comprises a third tape secured to a fourth tape, wherein the third set of fastener elements is located along an edge of the third tape and the fourth set of fastener elements is located along an edge of the fourth tape.

11. The rail track cover assembly of claim 1, wherein the fourth set of fastener elements are retained in the second channel of the elongated profile.

12. The rail track cover assembly of claim 1, wherein the fastener further comprises at least one slider configured to cause portions of the second and third set of fastener elements to selectively engage or disengage, wherein the at least one slider is configured to move with a seat structure.

13. A rail track cover assembly comprising:
a fastener comprising:
a first elongated fastener segment comprising a first set of fastener elements extending along the first elongated fastener segment; and
a second elongated fastener segment comprising a second set of fastener elements extending along the second elongated fastener segment, the first set of fastener elements configured to engage the second set of fastener elements in a releasable fashion; and
a reel configured to wind up a disengaged portion of the first elongated fastener segment.

14. The rail track cover assembly of claim 13, wherein the fastener further comprises a third elongated fastener segment configured to engage the first elongated fastener segment in a releasable fashion, wherein the first elongated fastener segment is between the second and third elongated fastener segments.

15. The rail track cover assembly of claim 14, further comprising:
a fourth elongated fastener segment of the fastener between the second and third elongated fastener segments, the fourth elongated fastener segment configured to engage the second and third elongated fastener segments in a releasable fashion; and
a second reel configured to wind up a disengaged portion of the fourth elongated fastener segment.

16. The rail track cover assembly of claim 13, wherein the reel is configured to move with a seat structure.

17. A rail track cover assembly comprising:
a first profile component comprising a first channel, the first channel comprising a first opening along a first side of the first profile component;
a second profile component comprising a second channel, the second channel comprising a second opening along a second side of the first profile component and such that the second opening is spaced apart and facing the first opening; and
a fastener between the first profile component and the second profile component, the fastener comprising:
a first elongated fastener segment comprising a first set of fastener elements and a second set of fastener elements;
a second elongated fastener segment comprising a third set of fastener elements and a fourth set of fastener elements; and
a third elongated fastener segment comprising a fifth set of fastener elements and a sixth set of fastener elements,
wherein:
the first set of fastener elements are retained in the first channel;
the second and third set of fastener elements are engaged in a releasable fashion;
the fourth and fifth set of fastener elements are engaged in a releasable fashion; and
the sixth set of fastener elements are retained in the second channel.

18. The rail track cover assembly of claim 17, wherein a portion of the third elongated fastener segment is configured to be disengaged from the first elongated fastener segment and the second elongated fastener segment based on movement of a seat structure.

19. The rail track cover assembly of claim 18, wherein the disengaged portion of the third elongated fastener segment is configured to pass through the seat structure.

20. The rail track cover assembly of claim 18, wherein the disengaged portion of the third elongated fastener segment is configured to pass above or below the seat structure.
